(19) United States
(12) Patent Application Publication
(10) Pub. No.: US 2020/0267272 A1
(43) Pub. Date: Aug. 20, 2020

(54) IMAGE FORMING APPARATUS, INFORMATION PROCESSING METHOD, AND RECORDING MEDIUM

(71) Applicant: GENKI UMEIZUMI, TOKYO (JP)

(72) Inventor: GENKI UMEIZUMI, TOKYO (JP)

(73) Assignee: Ricoh Company, Ltd., Tokyo (JP)

(21) Appl. No.: 16/789,817

(22) Filed: Feb. 13, 2020

(30) Foreign Application Priority Data
Feb. 15, 2019 (JP) 2019-025879

(51) Int. Cl. H04N 1/00

(52) U.S. Cl. CPC H04N 1/00466; H04N 1/00474; H04N 1/00456

(57) ABSTRACT

Example embodiments include an image forming apparatus including circuitry to: acquire an input image to be processed by the image forming apparatus; set additional processing to be performed on the input image or a printed material of the input image; display, on a display, a first image based on the input image; accept an operation to edit the input image based on the first image; and display, on the display, a second image in which a result of the additional processing is reflected in the first image being edited.

### CROSS-REFERENCE TO RELATED APPLICATIONS

This patent application is based on and claims priority pursuant to 35 U. S. C. § 119(a) to Japanese Patent Application No. 2019-025879, filed on Feb. 15, 2019, in the Japan Patent Office, the entire disclosure of which is hereby incorporated by reference herein.

### BACKGROUND

### Technical Field

The present invention relates to an image forming apparatus, an information processing method, and a recording medium.

### Description of the Related Art

In image formation, a method of displaying a finished state of an image, in other words, the so-called “preview”, before copying, etc., is known.

For example, when a user performs an operation to correct the orientation of an image, a stapling position, and a position where printing is to be performed in response to a displayed preview, a new preview reflecting the correction is displayed.

However, with a conventional method, a processing result of a plurality of processes is displayed in one preview, Therefore, it is difficult for the user to determine what operation to perform even by seeing the preview.

### SUMMARY

Example embodiments include an image forming apparatus including circuitry to: acquire an input image to be processed by the image forming apparatus; set additional processing to be performed on the input image or a printed material of the input image; display, on a display, a first image based on the input image; accept an operation to edit the input image based on the first image; and display, on the display, a second image in which a result of the additional processing is reflected in the first image being edited.

Example embodiments include an information processing method, and a recording medium storing a program for controlling information processing.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of general arrangement of an image forming apparatus;

FIG. 2 is a block diagram illustrating an example of a hardware configuration of each of an operation device and a main device;

FIG. 3 is a schematic view illustrating an example of an outer appearance of a part of the operation device;

FIG. 4 is a block diagram illustrating an example of a software configuration of each of the operation device and the main device;

FIG. 5 is a sequence diagram illustrating an example of overall processing performed by the image forming apparatus;

FIG. 6 is a sequence diagram illustrating an example of overall processing performed by the image forming apparatus;

FIG. 7 is a view illustrating an example of a processing result intended by a user in a first example;

FIG. 8 is a view illustrating an example of setting of an “erroneous” job condition in the first example;

FIG. 9 is a view illustrating a display example of a first preview (before editing) in the first example;

FIG. 10 is a view illustrating a display example of the first preview (after editing) in the first example;

FIG. 11 is a view illustrating a display example of a second preview in the first example;

FIG. 12 is a view illustrating a display example of a preview in a comparative example relative to the first example;

FIG. 13 is a view illustrating an example of a processing result intended by the user in a second example;

FIG. 14 is a view illustrating a display example of a first preview (before editing) in the second example;

FIG. 15 is a view illustrating a display example of the first preview (after editing) in the second example;

FIG. 16 is a view illustrating a display example of a second preview in the second example;

FIG. 17 is a view illustrating a display example of a preview in a comparative example relative to the second example;

FIG. 18 is a view illustrating target examples; and

FIG. 19 is a functional block diagram illustrating an example of a functional configuration of the image forming apparatus.

The accompanying drawings are intended to depict embodiments of the present invention and should not be interpreted to limit the scope thereof The accompanying drawings are not to be considered as drawn to scale unless explicitly noted,

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

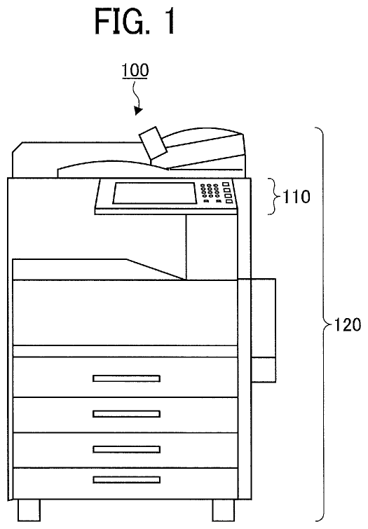

FIG. 1 is a schematic view illustrating an example of general arrangement of an image forming apparatus. As illustrated in FIG. 1, an image forming apparatus 100 is, for example, a multifunction peripheral (MFP). For example, the image forming apparatus 100 includes image processing functions such as a copy function, a scanner function, a facsimile function, and a printer function. The image forming apparatus 100 may further be provided with other functions (for example, an error display function).

In the present example, the image forming apparatus 100 includes an operation device 110 (example of a first device), and a structure (hereinafter referred to as a “main device 120”, as an example of a second device) other than the operation device 110.

A user inputs, to the operation device 110, various instructions to the image forming apparatus 100. Then, by the operation device 110 and the main device 120, the image forming apparatus 100 executes image processing based on the instructions.

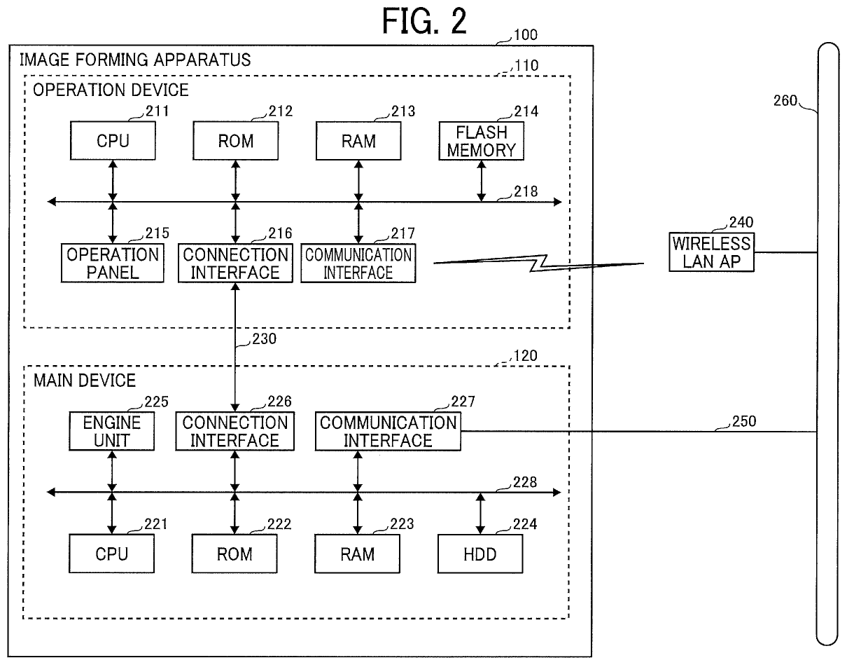

FIG. 2 is a block diagram illustrating an example of a hardware configuration of each of the operation device and the main device. Primarily, the operation device 110 is a device having a hardware configuration including, for example, a central processing unit (CPU: hereinafter referred to as a “CPU 211”), a read-only memory (ROM: hereinafter referred to as a “ROM 212”), a random access memory (RAM: hereinafter referred to as a “RAM 213”), a flash memory 214, an operation panel 215, a connection interface (hereinafter referred to as a “connection I/F 216”), and communication interface (hereinafter referred to as a “communication I/F 217”). Also, as illustrated in the drawing, the hardware resources are coupled to each other by a bus 218.

The CPU 211 operates as an arithmetic device and a control device. The CPU 211 executes various programs stored in, for example, the ROM 212 or the flash memory 214, by using a main storage device such as the RAM 213 as a work area. By such control and calculation, the CPU 211 controls the operation device 110 and the like, and implements various functions.

The flash memory 214 is an example of a nonvolatile recording medium. For example, the flash memory 214 stores programs and data.

The operation panel 215 is an example of an input device and an output device. That is, the operation panel 215 displays an operation screen, processing results, and the like. Also, the operation panel 215 accepts an operation by the user.

The connection I/F 216 is an interface which communicates with the main device 120 via a communication path 230. For example, the connection I/F 216 is a connector, a cable, and the like. Specifically, the connection I/F 216 enables the operation device 110 to perform communication via a universal serial bus (USB), etc.

The communication I/F 217 is an interface which communicates with an external device via a network 260. For example, the communication I/F 217 is an antenna or the like. In the example illustrated in the drawing, the communication I/F 217 is connected to a wireless local area network (LAN) access point (AP) (hereinafter referred to as a “wireless LAN AP 240”), and performs the communication.

Meanwhile, the main device 120 is a device having a hardware configuration including, for example, a CPU 221, a ROM 222, a RAM 223, a hard disk drive (HDD: hereinafter referred to as an “HDD 224”), an engine unit 225, a connection I/F 226, and a communication I/F 227. Also, as illustrated in the drawing, the hardware resources are coupled to each other by a bus 228.

The CPU 221 operates as an arithmetic device and a control device. As illustrated in the drawing, the CPU 221 for use in the main device 120 preferably operates independently from the CPU 211 for the operation device 110.

The ROM 222 and the RAM 223 are examples of storage devices for the main device 120 such as the CPU 221. Therefore, the CPU 221 uses a main storage device such as the RAM 223 to execute processing based on a program, etc., stored in an auxiliary storage device such as the ROM 222 and the HDD 224.

The engine unit 225 is a processing device for implementing the image processing functions such as the copy function, the scanner function, the facsimile function, and the printer function. Specifically, the engine unit 225 is, for example, a processing integrated circuit (IC). More specifically, the engine unit 225 includes a scanner which scans and reads a document, a plotter which performs printing on a sheet material such as paper, a communication circuit that implements facsimile communication, or a combination of the aforementioned elements. The engine unit 225 may include a device which sorts printed sheet materials, i.e., a device called “finisher”, or an automatic document feeder (ADF) which automatically feeds a document, etc.

The connection I/F 226 is an interface which communicates with the operation device 110 via the communication path 230. For example, the connection I/F 226 is a connector, a cable, and the like. Specifically, the connection I/F 226 performs the communication via a USB, etc.

The communication I/F 227 is an interface which communicates with an external device via the network 260. For example, the communication I/F 227 is a cable 250.

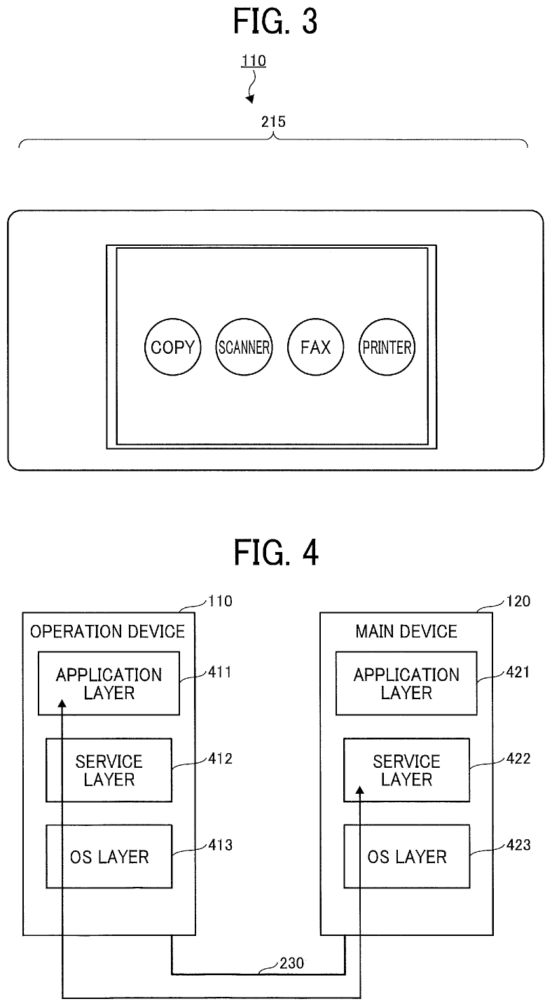

FIG. 3 is a schematic view illustrating an example of an outer appearance of a part of the operation device 110. For example, the operation device 110 is a device having the outer appearance as illustrated in the drawing. Specifically, the operation device 110 displays an operation screen for various functions provided by the image forming apparatus 100 through, for example, the operation panel 215. In the present example, the operation screen accepts an operation for the functions of “COPY”, “SCANNER”, “FAX”, and “PRINTER”. The illustrated example represents what is called a menu screen. For example, when a “COPY” button is pressed, the operation screen displays an operation screen for making the detailed setting for the “COPY” function.

Further, the illustrated example corresponds to an example of a configuration allowing setting of “initial settings” and an “address book”.

Also, when the user presses a button on the operation screen, a screen to be displayed next after transition or a setting value to be set, etc., is set by such as a menu configuration.

The operation device 110 is not necessarily implemented by the operation panel 215 as illustrated. For example, the operation panel 215 may include such as a hard key, in addition to a touch panel. In other words, a configuration which builds an interface for operating the operation screen may be one other than the configuration illustrated in the drawing.

FIG. 4 is a block diagram illustrating an example of a software configuration of each of the operation device and the main device. The illustrated example represents a hierarchical structure of software configured by programs installed in the operation device 110 and the main device 120.

First, the main device 120 is described. In the present example, in the main device 120, programs which construct, for example, an application layer 421, a service layer 422, and an operating system (OS) layer (hereinafter referred to as an “OS layer 423”) are installed in the auxiliary storage device or the like.

Programs categorized into the application layer 421 operate the hardware resources of the image forming apparatus 100, to implement various functions. Specifically, the programs categorized into the application layer 421 are, for example, a copy application, a facsimile application, a scanner application, and a printer application.

A program classified in the service layer 422 is a program existing between the application layer 421 and the OS layer 423. For example, a program classified in the service layer 422 implements an interface or the like allowing the program of the application layer 421 to use the hardware resource of the main device 120, or notifying the application layer 421 of the state of the hardware resource of the main device 120.

Also, a program classified in the service layer 422 accepts an operation request for the hardware resource or mediates the accepted operation request. Apart from the above, a program classified in the service layer 422 transmits an error detected in the hardware resource to the application layer 421 as an error notification. Note that the operation request accepted by the service layer 422 includes an operation request such as reading by a scanner, or printing by a plotter.

The role as the interface that the program classified in the service layer 422 implements is the same as the role to be played in an application layer 411 of the operation device 110. In other words, a program classified in the application layer 411 of the operation device 110 can access the service layer 422 to operate the hardware resources of the main device 120, to implement the image processing function and the like.

A program classified in the OS layer 423 is such as a program corresponding to the so-called “basic software”. Further, a program classified in the OS layer 423 provides a basic function for controlling the hardware resources of the main device 120. First, the program classified in the service layer 422 converts the operation request for the hardware resource, which is made by a program classified in the application layer 421, into a command that can be interpreted by the OS layer 423, and hands over the command to the OS layer 423. Further, as the program classified in the OS layer 423 executes the command, the image processing function is implemented based on the operation request for the hardware resource. Also, when the program classified in the OS layer 423 is executed, the hardware resource receives a detected error. Next, the hardware resource passes the received error notification to the service layer 422, which then sends the error notification to the application layer 421.

Next, the operation device 110 is described. In the present example, in the operation device 110, programs which construct, for example, the application layer 411, a service layer 412, and an OS layer 413 are installed in an auxiliary storage device or the like.

However, the function implemented by a program classified in the application layer 411, and the types of operation requests that can be accepted by the service layer 412, etc., are different from the function and the types in the main device 120. Specifically, in the operation device 110, a program classified in the application layer 411 provides a user interface function for performing an operation and display related to the image processing function implemented by the main device 120 mainly.

In the present example, the respective OSes of the operation device 110 and the main device 120 operate independently of each other. Also, as long as the operation device 110 and the main device 120 can communicate with each other, the types of the respective OSes may not be the same type. For example, a configuration in which the operation device 110 uses Android (registered trademark), and the main device 120 uses Linux (registered trademark) may be employed.

As described above, in the image forming apparatus 100, for example, the operation device 110 and the main device 120 are controlled by different OSes. Consequently, communication between the operation device 110 and the main device 120 is not interprocess communication within one device, but communication between different devices. For example, the communication mentioned above is command communication, whereby a user operation accepted by the operation device 110 is transmitted to the main device 120, or event communication (for example, an error notification or an error cancellation notification), whereby the main device 120 instructs the operation device 110 to display a display screen.

Also, if the type of OS is Android (registered trademark), etc., a plurality of applications can be started. Further, for example, if the “intent” function by the OS (hereinafter simply referred to as “intent”) is used, by specifying the application name of the application to be started, and application identification information such as the product identification (ID), one application can start another application via the OS.

Also, when the Intent is used, data or the like used in one application can be passed to the other application via the OS. For example, when the Intent is used, it is possible to specify an action of an application, more specifically, a second application, to be newly started via the OS, and data or the like to be passed from a first application to the second application via the OS.

In this example, the operation device 110 and the main device 120 may be formed as an integrated structure. In other words, the operation device 110 and the main device 120 may constitute a structure using the same hardware or the same OS, for example.

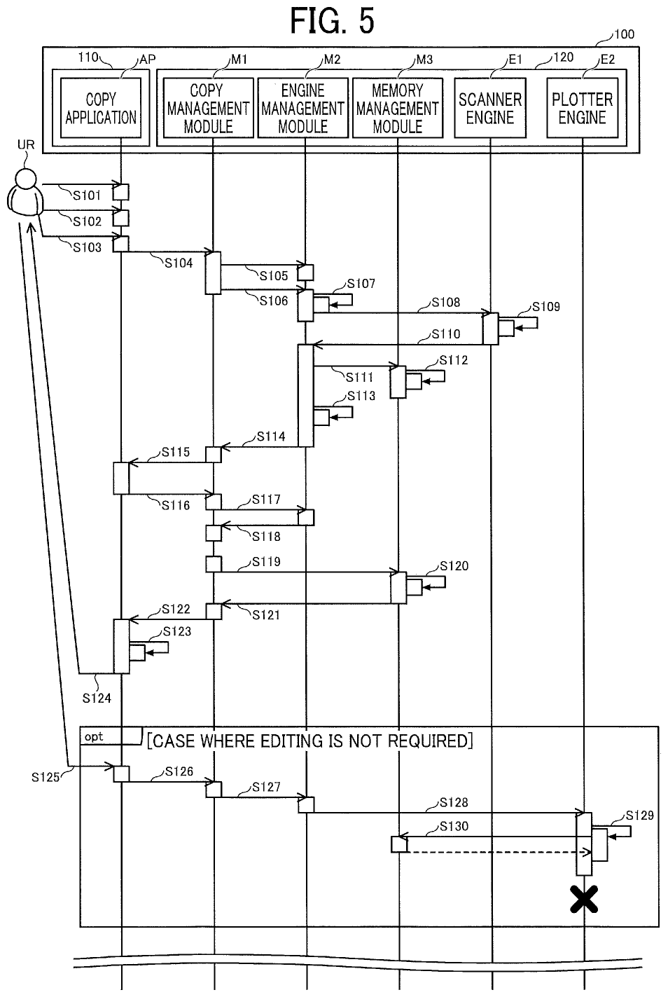

FIG. 5 is a sequence diagram illustrating an example of overall processing. First, as overall processing as illustrated in FIG. 5 is performed, the image forming apparatus 100 displays an image (hereinafter referred to as a “first image”) indicating a result of input processing, etc., having been performed, and also a preview (hereinafter referred to as a “first preview”).

In step S101, a copy application AP accepts an operation for starting the application.

In step S102, the copy application AP accepts an operation of setting a copy condition or the like to start the copying.

In step S103, the copy application AP accepts an operation for displaying a preview. For example, a user UR sets a job condition on the operation screen, and performs an operation of pressing a preview button.

Also, in the present example, the job condition includes, for example, the settings of processing to be performed by a peripheral device at a preset position or a preset area of an input image or a printed material on which the input image is printed, processing of adding preset character information to the preset position or the preset area, processing of adding a preset image to the preset position or the preset area, or a combination of the aforementioned types of processing (hereinafter referred to as “additional processing”).

As described above, the additional processing is processing for a preset position or a preset area of an input image or a printed material on which the input image is printed.

In this example, the processing to be performed by the peripheral device refers to processing by a device coupled to the image forming apparatus, in other words, a device called “finisher”. Accordingly, it suffices that the processing to be performed by the peripheral device is the so-called “post-processing”, and the type of processing varies depending on the type of the peripheral device. Specifically, the processing to be performed by the peripheral device refers to processing of performing stapling or punching and the like.

Also, adding the preset character information refers to, for example, adding a page number or a date to a header or a footer.

Further, the preset image refers to, for example, a character or a design indicating that the document is confidential. It suffices that the preset image is an image that can be set in advance in the image forming apparatus. Apart from the above, the preset image may be added in the form of a pattern or a watermarked image, for example.

Other than the above, the job condition includes, for example, choosing the printing from both side printing and one side printing, and the number of copies.

The setting of the job conditions may not be at the illustrated timing. For example, some of the settings such as the setting of the additional processing may be performed after the first preview has been displayed.

In step S104, the copy application AP gives an instruction to execute a preview, more specifically, a notification of a copy job, to a copy management module M1.

In step S105, the copy management module M1 performs setting of a copy job condition on an engine management module M2.

In step S106, the copy management module M1 requests the engine management module M2 for a preview start.

In step S107, the engine management module M2 starts the processing of displaying the preview. For example, the image forming apparatus performs the so-called “scanner processing”, which is to read an image formed on paper or the like by an input device such as a scanner, to generate an input image. In the following, a case where the input image is generated by the scanner processing is explained as an example. Alternatively, the input image may be input from such as an external device.

In step S108, the engine management module M2 requests a scanner engine E1 for the scanner processing.

In step S109, the scanner engine E1 executes the scanning processing. The scanner engine E1 reads the image formed on the paper or the like by the scanner processing, and generates an input image.

In step S110, the scanner engine E1 sends a result of execution of the scanner processing to the engine management module M2.

In step S111, the engine management module M2 requests the image to be saved.

In step S112, a memory management module M3 saves the image. It is assumed that the saved image is managed by a file ID.

In step S113, the engine management module M2 generates information for performing the preview. For example, the information for performing the preview corresponds to information on aggregation when the so-called “aggregation” is set. Also, the information for performing the preview corresponds to, when additional processing is performed, information indicating the setting, etc., of the additional processing.

In step S114, the engine management module M2 notifies the copy management module M1 that preparation for performing the preview is completed.

In step S115, the copy management module MI notifies the copy application AP that the preparation for performing the preview is completed.

In step S116, the copy application AP requests the copy management module M1 for preview display.

In step S117, the copy management module MI requests the engine management module M2 for information for performing the preview.

In step S118, the engine management module M2 sends the information for performing the preview. For example, the information for performing the preview is the file ID. The information for performing the preview may further include other information.

In step S119, the copy management module M1 requests the memory management module M3 to generate a thumbnail image. Therefore, the copy management module M1 sends information such as the file ID to the memory management module M3.

In step S120, the memory management module M3 generates a thumbnail image. More specifically, the memory management module M3 performs, for example, processing of reducing the image identified by the file ID, thereby generating the thumbnail image.

In step S121, the memory management module M3 sends the thumbnail image to the copy management module M1.

In step S122, the copy management module M1 sends such as the thumbnail image to the copy application AP.

In step S123, the copy application AP generates a preview image based on such as the condition. Note that an element other than the copy application AP may generate the image for preview. In this case, for example, the thumbnail image is first sent to a plotter engine E2 via the engine management module M2. Then, the plotter engine E2 generates the image for preview. After that, the image for preview is sent to the copy application AP via the engine management module M2. In this way, an element such as the plotter engine E2 may generate the image for preview.

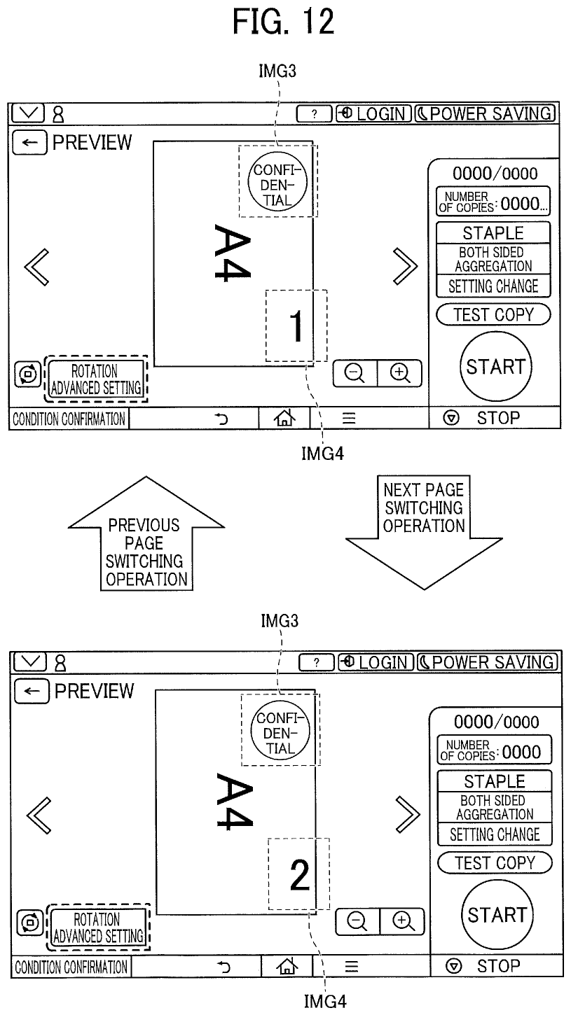

In step S124, the copy application AP displays the preview to the user UR. For example, in step S124, a screen illustrated in FIGS. 12A and 12B to be described later is displayed to the user.

The method for generating the first image and the method for displaying the first image may be implemented by processing other than the processing illustrated in the drawing.

As a result of confirmation of the first preview, if the job can be executed as presented by the first image ([CASE WHERE EDITING IS NOT REQUIRED]), the image forming apparatus proceeds to step S125.

In step S125, the copy application AP accepts an operation of pressing a button to start the printing.

In step S126, the copy application AP requests the copy management module M1 to start the printing.

In step S127, the copy management module M1 requests the engine management module M2 to start the printing.

In step S128, the engine management module M2 sends the file ID or the like to the plotter engine E2 to instruct the printing.

In step S129, the plotter engine E2 acquires an image corresponding to the file ID sent, and executes the printing.

In step S130, the plotter engine E2 requests the memory management module M3 for an image to be printed in the printing, and the memory management module M3 responds to the request by providing the image.

As described above, when the processing of step S125 to step S130 is performed, image processing of forming the image on paper or the like is performed, and the paper or the like on which the image processing is performed is discharged.

The processing of step S125 to step S130 may be performed in various ways other than the processing as illustrated.

Meanwhile, when the first image is to be edited, in other words, in a case where the user UR decides to change the orientation or the like of the image after seeing the first preview, the following processing is performed.

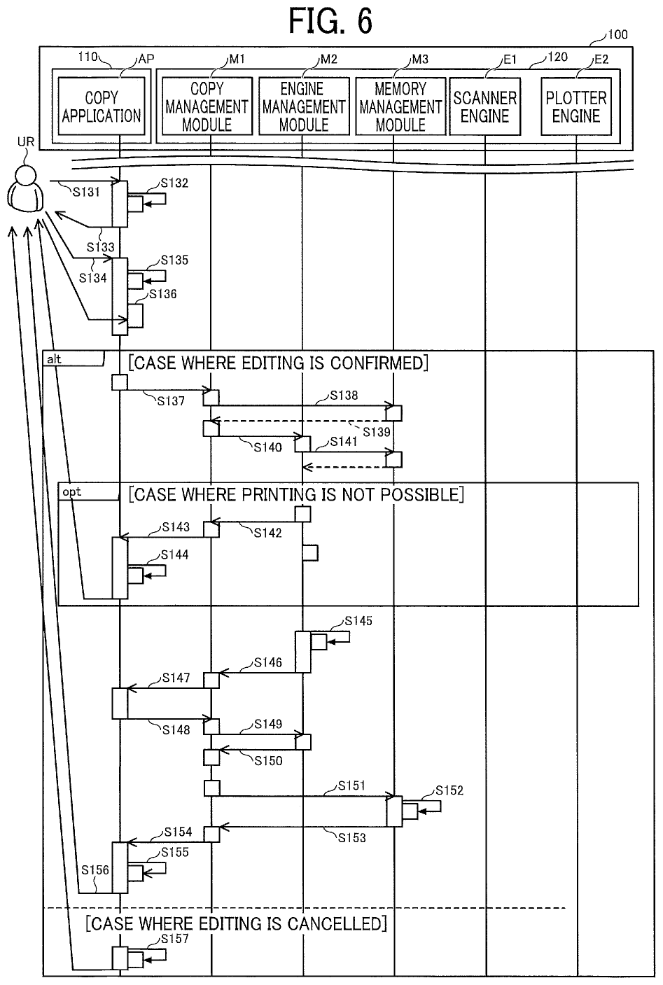

FIG. 6 is a sequence diagram (of second case) illustrating an example of the overall processing.

In step S131, the copy application AP accepts an operation for editing the first image. In step S131, preferably, operations related to a scan, such as an operation to rotate the first image, is accepted. In the following, editing in which an operation to rotate the first image is performed is explained as an example. That is, the present example corresponds to a case where the orientation of the first image displayed in the first preview is different from the orientation intended by the user UR. That is, in this case, the user UR performs the editing to rotate the first image to ensure that the first image is printed in the orientation as intended by the user UR.

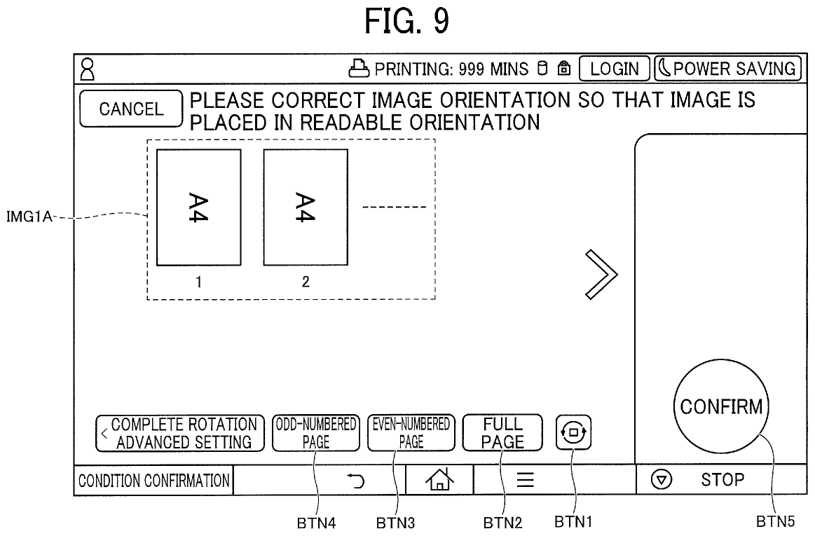

Also, when a “ROTATION ADVANCED SETTING” button illustrated in FIGS. 12A and 12B is pressed in step S131, a screen as illustrated in FIG. 9, for example, may be displayed.

Here, the editing may be an operation which includes, for example, enlarging the image, reducing the image, adjusting the position where the image is to be formed, or a combination of the above.

In step S132, the copy application AP generates an operation screen (hereinafter referred to as an “edit screen”) for allowing the user UR. to perform the editing. For example, in step S132, a preview illustrated in FIG. 9 is generated, based on information on a setting value of input processing and aggregation, of the information for performing the preview (that is, the information not based on an output processing setting value other than the aggregation).

In step S133, the copy application AP displays the edit screen to the user UR.

In step S134, the copy application AP accepts an editing operation for rotating the first image, which the user UR performs on the edit screen.

In step S135, the copy application AP saves edits. For example, the edits include a rotation angle of the image. The edits may be an operation for all of the pages, or an operation for each of the designated pages.

In step S136, the copy application AP determines whether to confirm or cancel the editing. For example, on the edit screen, the user UR is prompted to perform an operation of pressing a “CONFIRM” button to confirm the editing, or pressing a “CANCEL” button to cancel the editing. Further, based on the pressed button, the copy application AP determines the editing.

Next, when the editing is determined as being confirmed ([CASE WHERE EDITING IS CONFIRMED]), the image forming apparatus proceeds to perform step S137. Meanwhile, if the editing is determined to be cancelled ([CASE WHERE EDITING IS CANCELLED]), the image forming apparatus proceeds to perform step S157.

In step S137, the copy application AP notifies the copy management module M1 of the file ID and editing information, etc. The editing information includes, for example, edits such as the rotation angle input in the editing.

In step S138, the copy management module M1 notifies the memory management module M3 of the file ID and the editing information, etc. Further, the memory management module M3 generates an image representing a result of the editing (hereinafter referred to as an “edit image”), on the basis of the file ID and the editing information, etc.

In step S139, the memory management module M3 returns an edit result to the copy management module MI. That is, in the present example, the memory management module M3 sends, to the copy management module Ml, the edit image in which the image specified by the file ID is rotated as indicated by the editing information.

In step S140, the copy management module M1 requests the engine management module M2 for a preview of the edit image.

In step S141, the engine management module M2 requests the memory management module M3 for the edit image. Further, in response to the request, the memory management module M3 sends the edit image to the engine management module M2.

Preferably, the engine management module M2 determines whether printing has become impossible as a result of editing conducted based on the edit image. In the following, explanation is given according to an example in which the engine management module M2 determines feasibility of printing,

In step S141, the engine management module M2 determines whether printing is not unfeasible. For example, as the additional processing, it is assumed that the setting is made to perform stapling at two places on the left side of the paper. Further, it is assumed that the size of the paper is A3. In this case, in the initial state, in other words, in a state before editing, it is assumed that the setting is made to perform stapling on the short side of the paper.

After that, it is assumed that the image is rotated by 90° (as right-handed (also referred to as clockwise) rotation) by the editing. Further, the stapler setting is maintained before and after the editing. In this case, while the side to be stapled is the short side before editing, the side to be stapled is changed to the long side after editing as a result of the rotation performed by the editing. In such a case, processing becomes impossible depending on the peripheral device. In other, words, depending on the peripheral device, there may be specifications in which processing of performing the stapling on the short side is enabled, but the stapling on the long side is disabled. In such a case, the engine management module M2 determines that the printing is not possible ([Case where printing is not possible]).

Here, the determination is not limited to determination in the case as described above. In other words, it suffices that the engine management module M2 determines inclusion of processing which is practically impossible if editing is performed, based on the specifications of the image forming apparatus or the peripheral device. Accordingly, the criteria of determination, and the details of the processing to be determined may be related to features other than the stapler.

Therefore, when it is determined that the printing is not possible ([CASE WHERE PRINTING IS NOT POSSIBLE]), the image forming apparatus proceeds to step S142. In contrast, when it is determined that printing is not unfeasible, the image forming apparatus proceeds to step S145.

In step S142, the engine management module M2 notifies the copy management module M1 that the job involves unfeasible printing.

In step S143, the copy management module M1 notifies the copy application AP that the job involves unfeasible printing.

In step S144, the copy application AP generates a screen for informing the user UR that the job involves unfeasible printing, and displays the screen to the user UR, For example, a reason why printing is not possible is displayed on the screen. Alternatively, on the screen, a display in which a start button cannot be pressed may be presented, for example, to notify the user UR that printing cannot be executed. Further, preferably, the screen allows the user UR to perform an operation of changing the job condition or editing, etc. In other words, the user UR performs the operation of changing the job condition or editing, etc., so as to enable the printing by, for example, checking the reason why printing is not possible, When such an operation is performed, the image forming apparatus returns to step S131. By execution of the determination as described above, the image forming apparatus can inform the user of a case where printing is not possible.

Next, by the processing of step S145 to step S156, the image forming apparatus 100 displays a preview. For example, in step S145 to step S156, processing similar to the processing of step S113 to step S124 is performed. However, the preview displayed in step S156 reflects a result of the additional processing.

An image indicating a result of the output processing also reflecting the result of the additional processing set in the job condition is hereinafter referred to as a “second image”. Also, a preview displaying the second image is referred to as a “second preview”.

In step S157, the copy application AP displays such as the state before editing.

The illustrated processing employs a configuration in which the copy application AP is in the operation device 110, and the operation device 110 accepts the operation. However, the operation may be accepted by a way other than the above. For example, the main device 120 may accept such as the settings.

When the processing as described above is performed, the following processing result, for example, is obtained.

### Processing Result (First Example)

First, explanation is given for a case in which the user wishes to form an image and perform processing by a peripheral device as described below, for example, as the user's intention.

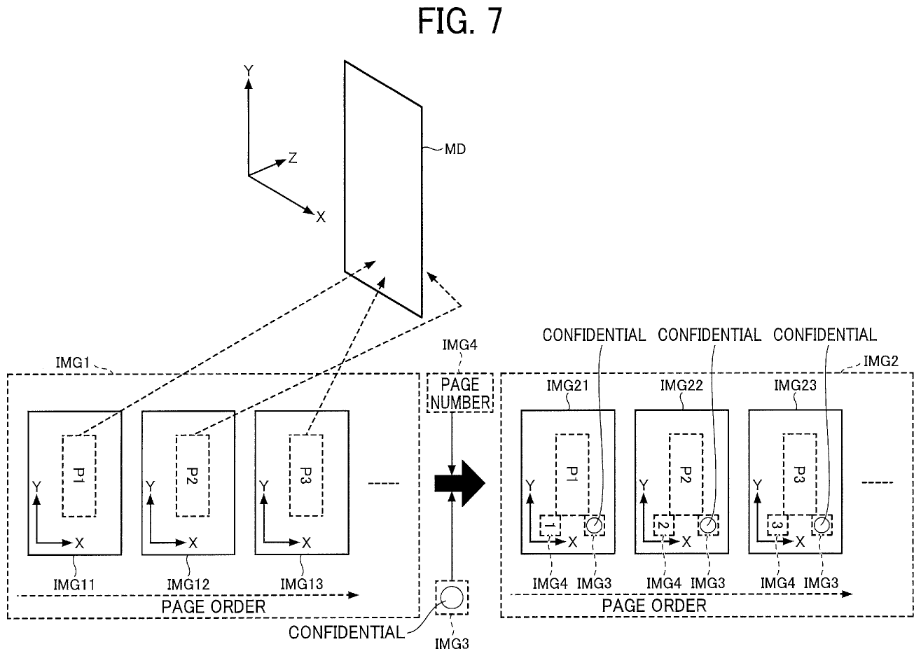

FIG. 7 is a view illustrating an example of a processing result intended by the user in a first example. First, in the following explanation, a case where images are printed on both sides of paper MD illustrated in FIG. 7 is taken as an example.

Also, in the following explanation, a plane of the paper MD is defined by an X-axis (horizontal direction) and a Y-axis (vertical direction). Further, a depth direction (corresponding to a thickness direction of the paper MD) is defined by a Z-axis.

Next, it is assumed that a first image IMG1 is generated by, for example, the scanner processing. Further, as illustrated in FIG. 7, it is assumed that the first image IMG1 corresponds to images of a plurality of pages such as a first input image 1MG11 constituting a first page of the first image IMG1, a second input image IMG12 constituting a second page of the first image IMG1, and a third input image IMG13 constituting a third page of the first image IMG1.

Also, as the user's intention, more specifically, the job condition, it is assumed that the setting is made to print the first image IMG1 by the so-called “both side printing”. Specifically, as illustrated in the drawing, each of the odd-numbered pages such as the first page and the third page is set to be printed on one side (hereinafter simply referred to as a “front”) of the paper MD. Further, each of the even-numbered pages such as the second page and the fourth page is set to be printed on a side different from the front (hereinafter simply referred to as a “back”).

As the job condition as described above is set, in the present example, it is assumed that the user's intention is to finally print a second image IMG2 as illustrated in FIG. 7.

Specifically, as the user's intention, first, it is assumed that the X-axis direction is intended as an up-and-down direction of an image with respect to the orientation of the image, as can be understood from the relationship between the first image IMG1 and the second image IMG2. In other words, the image is set to be printed in the image orientation as indicated by the second image IMG2, in such a state that editing such as rotation of the image is unnecessary with respect to a result of the scanner processing as indicated by the first image IMG1.

Further, it is assumed that the job condition is the setting of adding a confidential display mark IMG3, and a page number IMG4, which are examples of the preset image, to the first image IMG1, as illustrated in the drawing, and executing the printing. In other words, when the first image IMG1 and the second image IMG2 are compared, the second image IMG2 is different from the first image IMG1 in that the confidential display mark IMG3 and the page number IMG4 are added. Also, it is assumed that the user intends to set the position where the confidential display mark IMG3 and the page number IMG4 are to be added, and the orientation of the mark and page number, as illustrated in FIG. 7.

Specifically, the confidential display mark IMG3 and the page number IMG4 are set to be printed in the orientation in which the X-axis direction corresponds to the up-and-down direction.

Further, the confidential display mark IMG3 is the same image on all of the pages. Meanwhile, the page number IMG4 is a numerical value representing each page. Note that the page number IMG4 corresponds to an example in which the first page is represented as “1”. Therefore, in a first output image IMG21 corresponding to the first page of the second image IMG2, the page number IMG4, which is “1”, is added. Similarly, in a second output image IMG22 corresponding to the second page of the second image IMG2, the page number IMG4, which is “2”, is added. Further, in a third output image IMG23 corresponding to the third page of the second image IMG2, the page number IMG4, which is “3”, is added.

A case where the setting and the processing result as illustrated in the drawing are “correct” is explained below as an example. In other words, in the following explanation, execution of printing as the second image IMG2 illustrated in FIG. 7 is “correct”.

While the user's intention is as described above, it is assumed that the user has set the job condition as described below by mistake, for example.

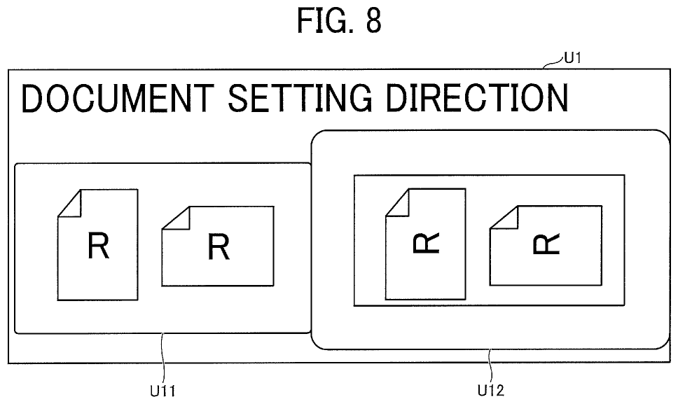

FIG. 8 is a view illustrating an example of setting of an “erroneous” job condition in the first example. For example, it is assumed that a user interface (UI) as illustrated in FIG. 8 is used to perform the operation of setting the job condition. In other words, the UI for setting a “DOCUMENT SETTING DIRECTION” (hereinafter referred to as a “direction setting screen U1”) includes a button (hereinafter referred to as a “first direction setting button U11”) for setting the image in the orientation in which the direction of scan is maintained, and a button (hereinafter referred to as a “second direction setting button U12”) for setting the image in the orientation in which the image is rotated relative to the direction of scan (by the rotation angle of 90° as left-handed [also referred to as counterclockwise] rotation in the example illustrated). In the example illustrated, the second direction setting button U12 is pressed. In other words, given that the user's intention is the printing as illustrated in FIG. 7, FIG. 8 represents an example of a case where the second direction setting button U12 is pressed by mistake instead of pressing the first direction setting button U11.

Resulting in an “erroneous” setting as in the first example is not necessarily caused by an erroneous operation of pressing the incorrect button on the direction setting screen U1. That is, the state being “erroneous” as in the first example depends on the relationship between the orientation in which a document to be read (hereinafter simply referred to as a “document”) is set relative to a scanner and the setting in the direction setting screen U1. Accordingly, even if the first direction setting button U11 is pressed, if the document or the like is set in an incorrect orientation relative to the scanner, the state similarly turns out to be “erroneous”.

Therefore, the image forming apparatus 100 first displays the first preview as indicated below, for example, by the processing illustrated in FIG. 5.

FIG. 9 is a view illustrating a display example of the first preview (before editing) in the first example. The illustrated screen is the edit screen which displays the first preview indicating the first image before editing (hereinafter referred to as an “unedited image IMG1A”), and by which editing of rotation by a rotation button BTN1 can be performed.

In this example, the editing may be performed for all of the pages in common by pressing a full-page button BTN2. Meanwhile, in the editing, by pressing an even-numbered page button BTN3 and an odd-numbered page button BTN4, the setting may be performed separately for each of the odd-numbered pages, that is, the front, and each of the even-numbered pages, that is, the back.

For example, when editing to rotate the unedited image IMG1A (by a rotation angle of 270° as the right-handed rotation) is performed by an operation of pressing the rotation button BTN1, the “erroneous” setting can be corrected to achieve the job setting that conforms to the user's intention. For example, the following first preview reflecting the editing is displayed.

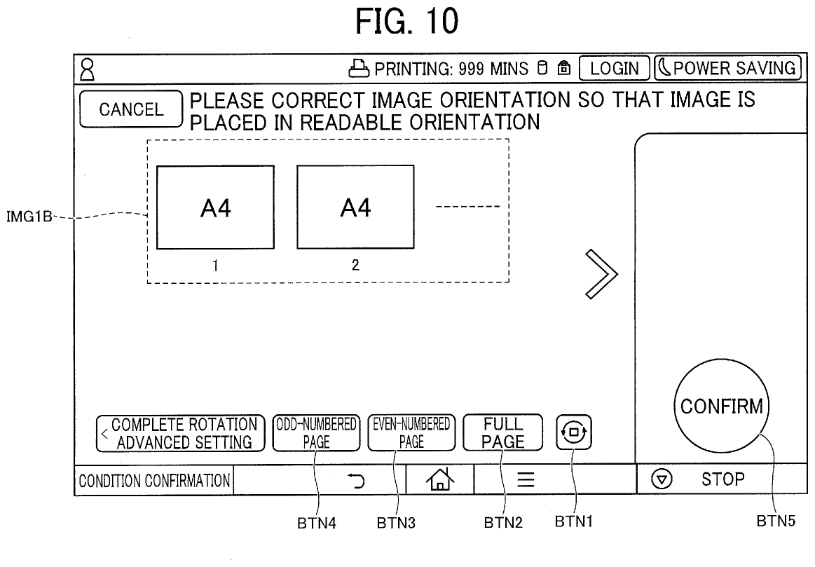

FIG. 10 is a view illustrating a display example of the first preview (after editing) in the first example. As compared to FIG. 9, FIG. 10 is different in that the editing is reflected in the illustrated first preview, and the rotated first image (hereinafter referred to as an “edited image IMG1B”) is displayed. Accordingly, as the user sees the first preview of the edited image IMG1B as illustrated in the drawing, and presses a “CONFIRM” button BTNS, the editing is confirmed, and the second preview is displayed. For example, the second preview is displayed as described below.

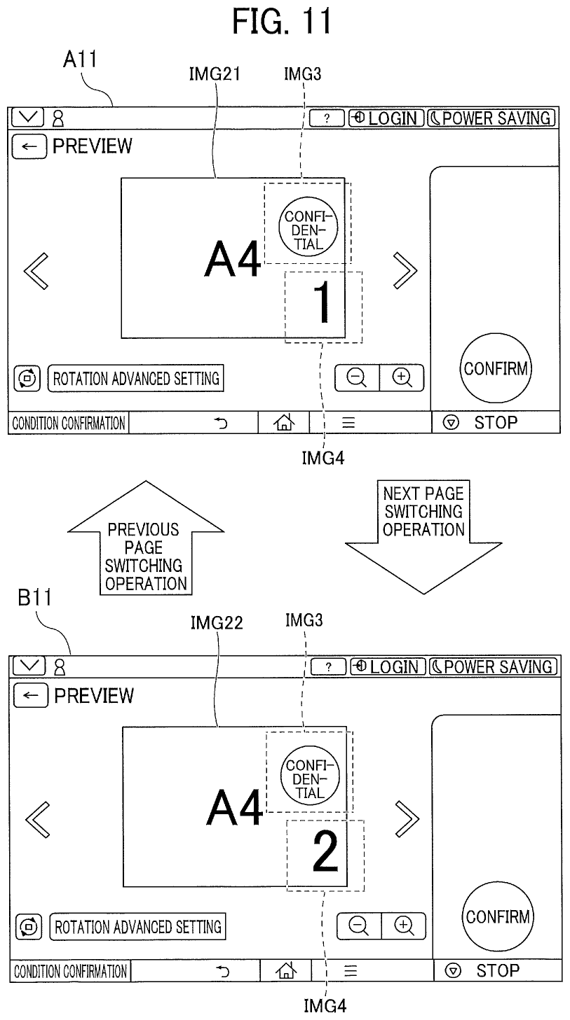

FIG. 11 is a view illustrating a display example of the second preview in the first example. The illustrated example corresponds to an example in which the second preview is displayed per page. Specifically, FIG. 11 illustrates the second preview A11 of the first page and also illustrates the second preview B11 of the second page. For example, when a page switching button is pressed, and one of a “NEXT PAGE SWITCHING OPERATION” and a “PREVIOUS PAGE SWITCHING OPERATION” is performed, the second preview switches the page to be displayed as illustrated in the drawing. Alternatively, in the second preview, a plurality of pages may be displayed on one screen.

As compared to the first preview, the second preview is different from the first preview in that the edited image IMG1B reflects a result of the additional processing such as addition of the confidential display mark IMG3 and the page number IMG4.

Preferably, the image forming apparatus accepts an operation for changing the additional processing in the second image, in other words, an operation for changing the additional processing after the second preview has been displayed. Examples of the operation for changing the additional processing in the second image include an operation of changing the positions where the confidential display mark IMG3 and the page number IMG4 are added (in the example illustrated, the confidential display mark IMG3 is set at the “upper right” position). Also, another example is an operation of changing the direction in which the additional processing is performed (in the example illustrated, the confidential display mark IMG3 and the page number IMG4 are set in such an orientation that the X axis corresponds to the up-and-down direction). The user can understand the situation more easily if the display of a preview and acceptance of an operation are performed in such an order.

If the previews are displayed separately as the first preview and the second preview, as illustrated in the drawings, the user can easily understand that the “DOCUMENT SETTING DIRECTION” is incorrect. Consequently, the user can easily make correction to print the image as intended, as illustrated in the drawings. Comparative Example relative to First Example

It is assumed that a comparative example corresponds to a case where editing is not performed due to the setting of an “erroneous” job condition, and a result of the output processing is displayed as described below, for example, without display of the first preview.

FIG. 12 is a view illustrating a display example of a preview in a comparative example relative to the first example. Similarly to FIG. 11, it is assumed that the preview is displayed per page.

In the comparative example, an “erroneous” operation has been performed as illustrated in FIG. 8. The preview of the comparative example displays a result of the additional processing together with the “erroneous” input processing. As compared to the user's intention, in other words, as compared to FIG. 7, because of the erroneous setting for input in the job setting, the confidential display mark IMG3 and the page number IMG4 are set in such an orientation that the Y axis corresponds the up-and-down direction.

As described above, in the present example, the setting in the direction setting screen U1 is erroneous. Therefore, if editing is performed to rotate the first image as indicated in the above first example, printing can be executed as intended by the user.

Meanwhile, a preview as illustrated in the drawing, in other words, a case where the input and output conditions are displayed altogether in the preview is assumed. In this case, it is often difficult for the user to determine whether the setting regarding input such as the setting in the direction setting screen U1 is erroneous, or the setting regarding output such as the direction in which the additional processing is performed is erroneous.

In other words, in the comparative example, the user may perform an operation to change the orientation of the confidential display mark IMG3 and the page number IMG4, for example, to correct the “erroneous” state. With such an operation, it may be difficult to make the setting to perform the printing as intended by the user.

### Processing Result (Second Example)

First, explanation is given for a case in which the user wishes to form an image and perform processing by a peripheral device as described below, for example, as the user's intention.

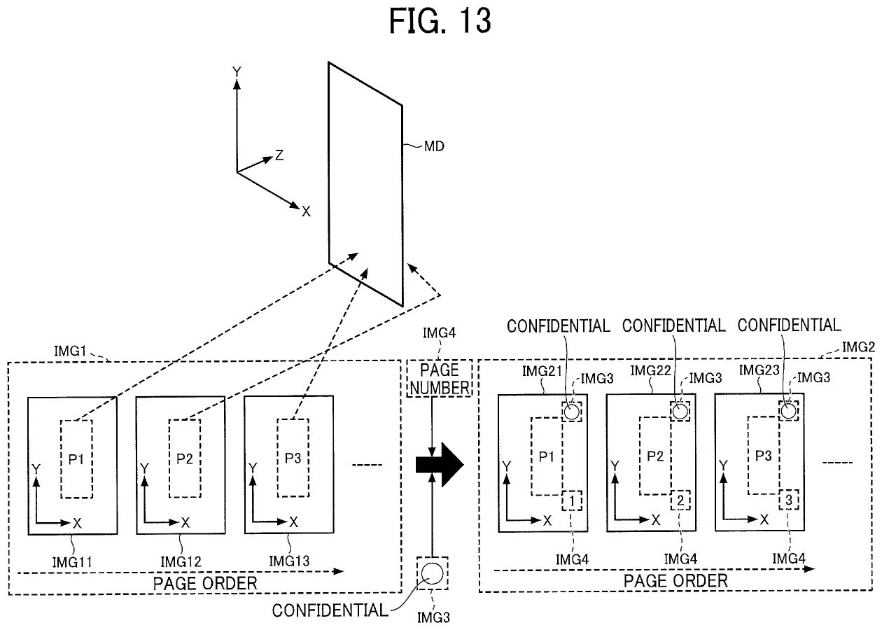

FIG. 13 is a view illustrating an example of a processing result intended by a user in a second example. As compared to the first example, the second example is different in that the image is printed in such an orientation that the Y axis corresponds to the up-and-down direction. In the following, points that are the same as the points in the first example are omitted from the explanation.

A case where the setting and the processing result as illustrated in the drawing are “correct” is explained below as an example.

The second example corresponds to an example in which the user made a mistake in the setting of the so-called “spread”. Specifically, according to the user's intention, for the odd-numbered page and the even-numbered page, the setting is made to perform scanning in such a way that images are oriented in the same up-and-down direction. In other words, the setting of the so-called “left-right spread” is to be made. In addition, a document to be read is set in an orientation for the left-right spread. When all of the above is satisfied, the setting is “correct”.

In contrast, in the following example, an erroneous case in which the setting of the left-right spread is made, and the document to be read is set in an orientation for a top-bottom spread for scan is explained as an example.

Therefore, the image forming apparatus first displays the first preview as indicated below, for example, by the processing illustrated in FIG. 5.

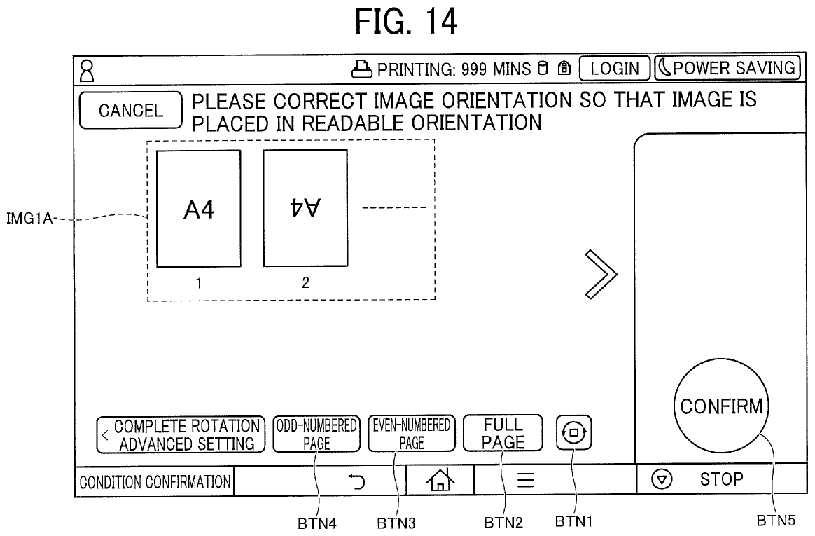

FIG. 14 is a view illustrating a display example of a first preview (before editing) in the second example. From the screen as illustrated in the drawing, it is understood that while the odd-numbered page such as the first page is “correct” as intended by the user, the even numbered page such as the second page is “erroneous” in terms of the orientation of the image in the up-and-down direction.

To deal with such a state, editing to perform the operation of, for example, pressing the even-numbered page button BTN3, and also the rotation button BTN1, to rotate the unedited image IMG1A (by a rotation angle of 180° as the right-handed rotation) may be carried out. By doing so, the “erroneous” setting can be corrected to achieve the job setting as intended by the user. For example, the following first preview reflecting the editing is displayed.

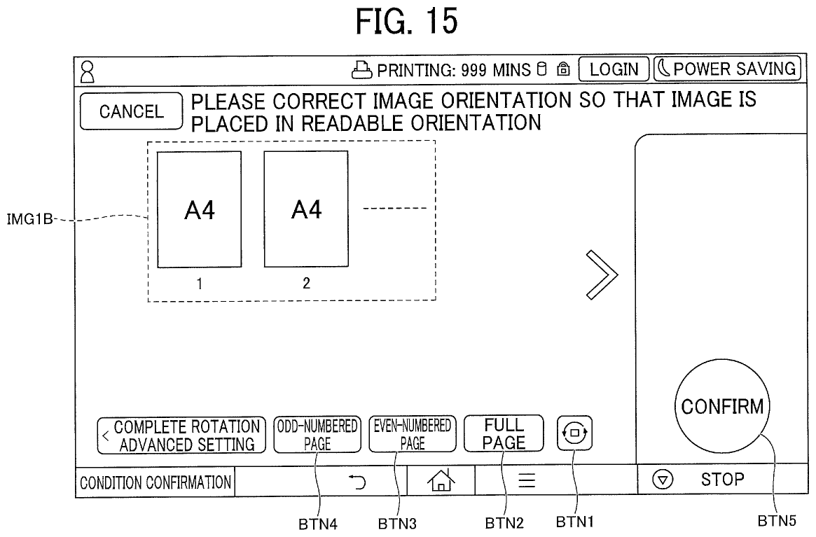

FIG. 15 is a view illustrating a display example of the first preview (after editing) in the second example. As compared to FIG. 14, FIG. 15 is different in that the editing is reflected in the illustrated first preview, and the edited image IMG1B with the images on the even-numbered pages being rotated is displayed. Accordingly, as the user sees the first preview of the edited image IMG1B as illustrated in the drawing, and presses the “CONFIRM” button BTN5, the editing is confirmed, and the second preview is displayed. For example, the second preview is displayed as described below.

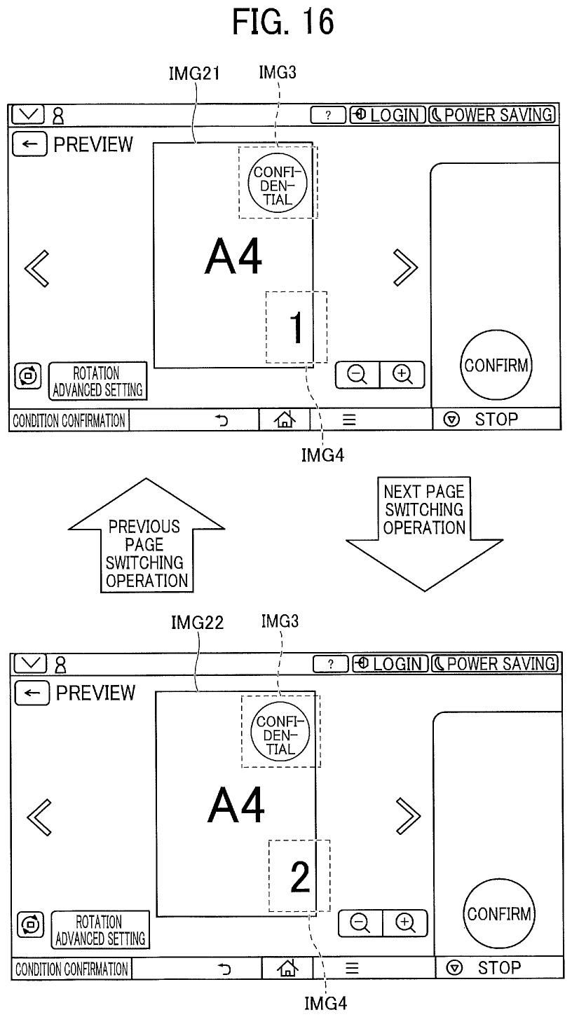

FIG. 16 is a view illustrating a display example of the second preview in the second example. As in the first example, the illustrated example corresponds to an example in which the second preview is displayed per page.

It is assumed that the setting of the additional processing in the second example is the same as the setting in the first example. If such assumption applies, as compared to the first preview, the second preview is different from the first preview in that a result of the additional processing such as addition of the confidential display mark IMG3 and the page number IMG4 is reflected in the edited image IMG1B, as in the first example.

Also, as in the first example, preferably, the image forming apparatus accepts an operation for changing the additional processing in the second image, in other words, an operation for changing the additional processing after the second preview has been displayed.

If the previews are displayed separately as the first preview and the second preview, as illustrated in the drawings, the user can easily understand that the “spread” is incorrect. Consequently, the user can easily make correction to print the image as intended, as illustrated in the drawings.

### Comparative Example Relative to Second Example

As in the first example, in the following, a comparative example, which corresponds to a case where editing is not performed due to the setting of an “erroneous” job condition, and a result of the output is displayed as described below, for example, without display of the first preview, is explained.

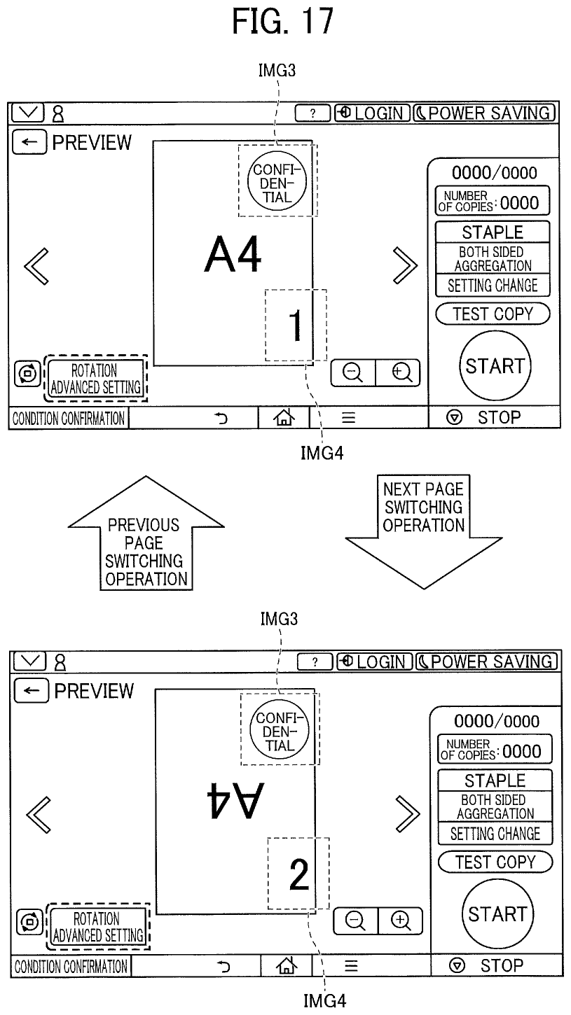

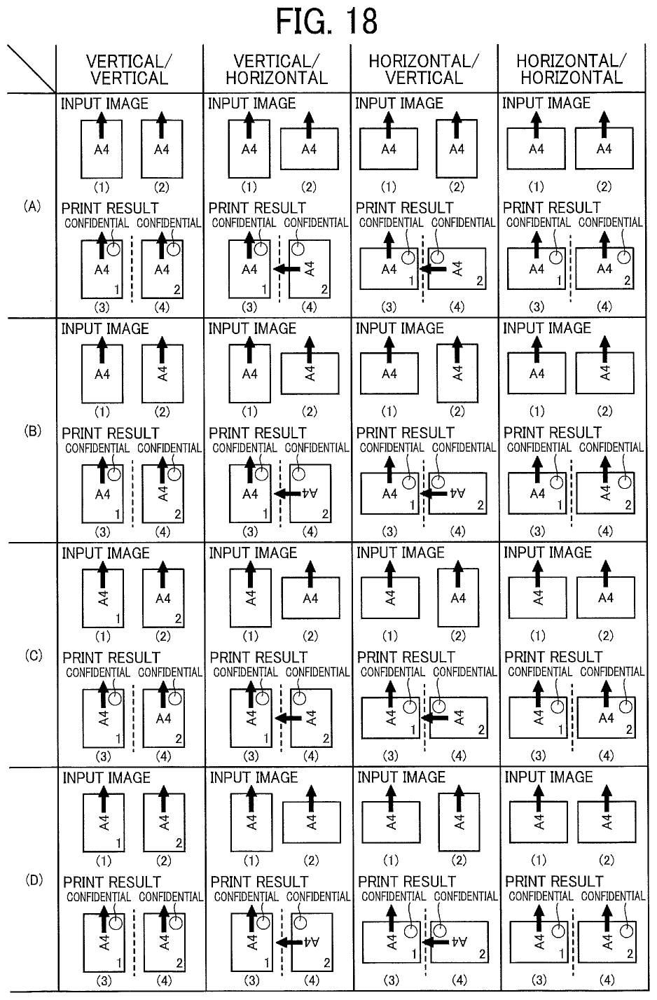

FIG. 17 is a view illustrating a display example of a preview in a comparative example relative to the second example. Similarly to FIG. 11, etc., it is assumed that the preview is displayed per page.

In the comparative example, an “erroneous” operation has been performed in the setting of the “spread”. The preview of the comparative example displays a result of the additional processing together with the “erroneous” input processing. In this case, the setting or the like of the input processing is erroneous. Therefore, as compared to the user's intention, in other words, as compared to FIGS. 13A to 13C, the setting causes printing to be executed with the orientation of the input image being reversed in the up-and-down direction on the even-numbered pages.

As described above, in the present example, the setting of the “spread” is erroneous. Therefore, the present case corresponds to a case where printing can be executed as intended by the user if editing is performed to rotate the first image on the even-numbered pages, as illustrated in FIG. 14.

Meanwhile, a preview as illustrated in the drawing, in other words, a case where such as a result of the input processing and a result of the output processing are displayed altogether in the preview is assumed. In this case, since such as the positions and orientations of the confidential display mark IMG3 and the page number IMG4 are as intended by the user in the preview, the user who has seen the preview may consider that if editing is performed to rotate the first image on the even-numbered pages, the confidential display mark IMG3 and the page number IMG4 are also rotated. As described above, by a preview as illustrated in the drawing, the relationship between the editing and the image is often difficult to understand.

More specifically, in the present comparative example, there may be a case where the user wishes to correct the “erroneous” state, for example, but is uncertain of the operation to rotate the image on the even-numbered pages while maintaining the orientation, etc. , of the confidential display mark IMG3 and the page number IMG4.

The present embodiment is directed to, for example, situations as described below.

FIG. 18 is a view illustrating target examples. The horizontal axis classifies the image orientation relative to paper with respect to the input image. Meanwhile, the vertical axis classifies the combination of a setting direction for the scanner and the setting of a spread.

In FIG. 18, “INPUT IMAGE” represents a result of the input processing. Meanwhile, “PRINT RESULT” represents a result of the output processing. Further, in the present example, it is assumed that the setting for output is to print a confidential display mark at the “upper right” position of the image. Furthermore, in the present example, it is assumed that the setting for output is to print a page number at the “lower right” position of the image. Also, in each pattern, “(1)” and “(3)” indicate the odd-numbered page, and “(2)” and “(4)” indicate the even-numbered page.

On the horizontal axis, as illustrated in (A) of the vertical axis, “VERTICAL/VERTICAL” represents a case where the up-and-down direction of the input image agrees with the orientation of the long side of the paper. Further, it is assumed that on both of the odd-numbered page and the even-numbered page, the image orientation is the same.

On the horizontal axis, as illustrated in (A) of the vertical axis, “VERTICAL/HORIZONTAL” represents a case where the up-and-down direction of the input image agrees with the orientation of the long side of the paper on the odd-numbered page, and the up-and-down direction of the input image agrees with the orientation of the short side of the paper on the even-numbered page.

On the horizontal axis, as illustrated in (A) of the vertical axis, “HORIZONTAL/VERTICAL” represents a case where the up-and-down direction of the input image agrees with the orientation of the long side of the paper on the even-numbered page, and the up-and-down direction of the input image agrees with the orientation of the short side of the paper on the odd-numbered page.

On the horizontal axis, as illustrated in (A) of the vertical axis, “HORIZONTAL/HORIZONTAL” represents a case where the up-and-down direction of the input image agrees with the orientation of the short side of the paper. Further, it is assumed that on both of the odd-numbered page and the even-numbered page, the image orientation is the same.

That is, it is assumed that four patterns illustrated in (A) of the vertical axis are cases where the setting direction of a document, which is a target of input processing, and the setting of “spread” are “correct”, and the image is output as intended by the user.

In contrast, if the setting direction of a document is “correct”, and the setting of “spread” is “incorrect”, the outcomes are as illustrated in (B) of the vertical axis.

Further, in contrast to (A) of the vertical axis, if the setting direction of a document is “incorrect”, and the setting of “spread” is “correct”, the outcomes are as illustrated in (C) of the vertical axis.

Furthermore, in contrast to (A) of the vertical axis, if the setting direction of a document is “incorrect”, and the setting of “spread” is also “incorrect”, the outcomes are as illustrated in (D) of the vertical axis.

For example, in the case of (D) of the vertical axis of “VERTICAL/VERTICAL” of the horizontal axis, in a preview, the image may be seen as if a “top-bottom spread” is presented. Consequently, the user may enter an edit to rotate the odd-numbered page (by 90° as the right-handed rotation). When such editing is performed, the outcome will be as illustrated in (B) of the vertical axis of “HORIZONTAL/VERTICAL” of the horizontal axis. That is, as can be seen from comparison between (B) of the vertical axis of “HORIZONTAL/VERTICAL” of the horizontal axis and (A) of the vertical axis of “HORIZONTAL/VERTICAL” of the horizontal axis, the front is “correct” because the state of the odd-numbered page (3) matches with each other in (A) and (B) of the vertical axis. On the other hand, as regards the back, despite “correct” additional processing for the confidential display mark and the page number, for example, the image orientation is “incorrect”, as illustrated by the state of the even-numbered page (4).

As seen from the above, when processing such as the additional processing is added, the image orientation and the way of editing, for example, may become hard to understand for the user. Such difficulty is encountered in both side printing, in particular. In such cases, it is desirable that an image forming apparatus according to the present embodiment, which is capable of providing a user-friendly UI, be used.

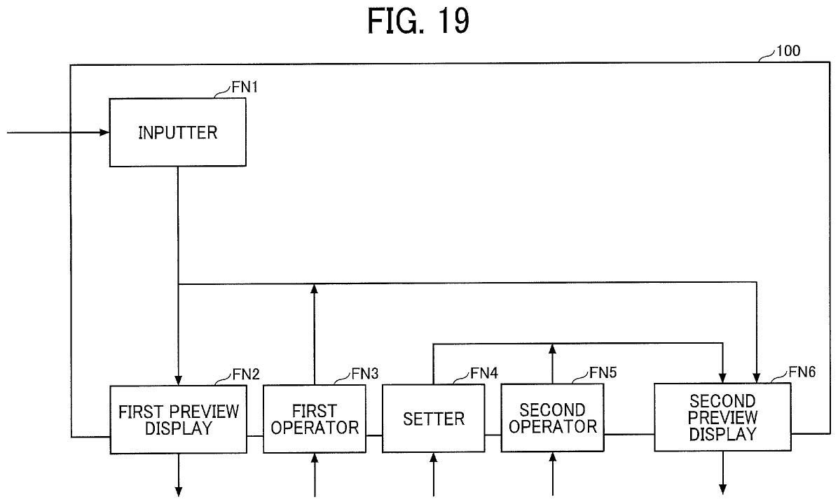

FIG. 19 is a functional block diagram illustrating an example of a functional configuration of the image forming apparatus. For example, the image forming apparatus has a functional configuration including an inputter FN1, a first preview display FN2, a first operator FN3, a setter FN4, and a second preview display FN6. Also, preferably, as illustrated in FIG. 19, the image forming apparatus 100 has a functional configuration further including a second operator FN5. In the following, explanation is provided by referring to the illustrated functional configuration as an example.

The inputter FN1 performs an input process of inputting an input image. For example, the inputter FN1 is realized by an input device or the like of the image forming apparatus.

The first preview display FN2 performs a first preview display process of displaying the first image on the basis of the input image. For example, the first preview display FN2 is realized by the operation panel 215.

The first operator FN3 performs a first operation process of accepting an operation for editing the first image. For example, the first operator FN3 is realized by the operation panel 215.

The setter FN4 performs a setting process of setting the additional processing. For example, the setter FN4 is realized by the operation panel 215.

The second preview display FN6 performs a second preview display process of displaying the second image in which a result of the additional processing is reflected in the first image. For example, the second preview display FN6 is realized by the operation panel 215.

The second operator FN5 performs a second operation process of accepting an operation for changing the additional processing directed to the second image. For example, the second operator FN5 is realized by the operation panel 215.

An application such as a copy application assumes a state in which the scanner processing, etc., is performed, and a state in which an image is printed on paper, etc.

The first image represents a result of the input processing such as the scanner processing. In contrast, the second image represents a result of the output processing including a processing result of the additional processing, etc. In this way, it is desirable that the previews be displayed separately, such as displaying the first preview in which the result of the input processing is indicated, and the second preview in which the additional processing is also considered.

If the final printed state is previewed at once, when the user finds that the printing is to be performed differently from the user's intention, it is often difficult for the user to determine whether the image orientation, imposition, front and back relationship, and the direction in which the document is set are erroneous, or the setting regarding the additional processing is erroneous. For this reason, for example, when editing is performed to rotate the image on the front, it may be difficult to determine whether the editing is also to be performed on the back, and the additional processing such as a stamp is also to be rotated. In other words, the exact place that is “erroneous” may not be precisely conveyed to the user.

Accordingly, the present embodiment has adopted the functional configuration as illustrated. Thus, even if the direction in which a document is set is erroneous, for example, if the previews are displayed separately, the user can easily understand the outcome of an operation when the error is corrected by the operation such as editing. In this way, with an easily comprehensible UI, the user can easily understand such as the relationship between the operation and the image. As described above, if the previews are separated for a result of the input processing and a result of the output processing, the user can easily modify the image orientation and the like “correctly”.

In particular, when the additional processing is performed in a condition of both side printing, it is often difficult for the user to determine what operation to perform to correct the erroneous state. In contrast, if the UI realized in the present embodiment is used, a preview enabling the user to easily confirm the outcome of operation can be displayed.

Note that all of or a part of the processes according to the present invention may be realized by a program which is written in a low-level programming language or a high-level programming language, and causes a computer to execute an information processing method. In other words, the program is a computer program for causing the computer such as an image forming apparatus or an image forming system to execute each of the processes.

Therefore, when the information processing method is executed on the basis of the program, an arithmetic device and a control device of the computer performs the calculation and control on the basis of the program, in order to execute each of the processes. Also, a storage device of the computer stores data for use in the process on the basis of the program, in order to execute each of the processes.

In addition, the program can be recorded on a computer-readable recording medium and distributed. The recording medium is a medium such as a magnetic tape, a flash memory, an optical disk, a magneto-optical disk, or a magnetic disk. Further, the program can be distributed through a telecommunication line.

Note that the embodiment according to the present invention may be implemented by the image forming system. Also, the image forming system may execute each of the processes by redundancy, decentralization, parallelization, or virtualization, or by combining the above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus comprising circuitry configured to:
acquire an input image to be processed by the image forming apparatus;
set additional processing to be performed on the input image or a printed material of the input image;
display, on a display, a first image based on the input image;
accept an operation to edit the input image based on the first image; and
display, on the display, a second image in which a result of the additional processing is reflected in the first image being edited.

2. The image forming apparatus according to claim 1, further comprising an image forming device configured to form an image on a recording sheet based on the input image obtained by performing the additional processing on the input image being edited.

3. The image forming apparatus according to claim 1, wherein the circuitry is further configured to accept an operation to change the additional processing based on the second image.

4. The image forming apparatus according to claim 1, wherein:
the first image represents the input image corresponding to a result of input processing, the input processing being at least one of processing to scan a document into data and processing to acquiring data from the outside; and
the second image represents an image reflecting the result of the additional processing corresponding to a result of output processing.

5. The image forming apparatus according to claim 4, wherein the additional processing is at least one of processing to be performed by a peripheral device coupled to the image forming apparatus, processing of adding character information, and processing of adding an image.

6. The image forming apparatus according to claim 1, wherein the operation to edit the input image includes an operation to rotate the first image.

7. The image forming apparatus according to claim 2, wherein the image forming device forms images on both sides of the recording sheet.

8. The image forming apparatus of claim 2, comprising:
a first device configured to receive inputs from a user; and
a second device including the image forming device, wherein the circuity includes first circuitry on the first device and second circuitry on the second device, the first circuitry and the second circuitry being independent from each other.

9. An information processing method comprising:
acquiring an input image to be processed by an image forming apparatus;
setting additional processing to be performed on the input image or a printed material of the input image;
displaying, on a display, a first image based on the input image;
accepting an operation to edit the input image based on the first image; and
displaying, on the display, a second image in which a result of the additional processing is reflected in the first image being edited.

10. A non-transitory recording medium storing a plurality of instructions which, when executed by one or more processors, cause the processors to perform a method, the method comprising:
acquiring an input image to be processed by an image forming apparatus;
setting additional processing to be performed on the input image or a printed material of the input image;
displaying, on a display, a first image based on the input image;
accepting an operation to edit the input image based on the first image; and
displaying, on the display, a second image in which a result of the additional processing is reflected in the first image being edited.
